(19) United States
(12) Patent Application Publication
(10) Pub. No.: US 2011/0246553 A1
(43) Pub. Date: Oct. 6, 2011

(54) VALIDATION OF INTERNAL DATA IN BATCH APPLICATIONS

(76) Inventors: Mahesh K. Somani, Milpitas, CA (US); Kumar Rethinakaleeswaran, San Jose, CA (US); Debashis Saha, San Jose, CA (US)

(21) Appl. No.: 12/755,300

(22) Filed: Apr. 6, 2010

(51) Int. Cl. G06F 15/16; G06F 9/46; G06F 3/048; G06F 12/08

(52) U.S. Cl. 709/202; 718/101; 715/764; 711/118; 711/E12.016

(57) ABSTRACT

A method and a system provide validated internal data about a running batch application. The validated internal data may be accessed via administrative interface for batch application for monitoring and management. The system comprises a batch host to host an instance of a running batch application. The running batch application comprises an interface to a batch agent. A controller is in communication with the batch agent and requests validated internal data about the running batch application via the batch agent. The controller further receives the validated internal data about the running batch application from the batch agent.

### TECHNICAL FIELD

The present application relates generally to the technical field of distributed computing and, in one specific example, to internal validation of batch applications.

### BACKGROUND

Batch applications are used to perform large tasks in a distributed computing environment. Batch applications are offline (e.g., non-real time) applications, are run by central master servers that control slave clients, and may be performed using predetermined pathways and commands. The batch applications are executed on the slave clients upon receiving a command from the master server and only communicate a final report to the master server when the batch application is complete. During the execution of a batch application, the only operation that the master server can perform is to terminate the batch application. Examples of offline transactions that may be performed as a part of a batch application in an e-commerce environment include creating invoices, creating reminders, sending out electronic announcements or wish lists to users, counting errors, payroll, sending batch emails, moving data between hardware resources, restructuring data within one or more hardware resources, and the like.

### BRIEF DESCRIPTION OF THE DRAWINGS

Some embodiments are illustrated by way of example and not limitation in the figures of the accompanying drawings in which:

FIG. 1 is a network diagram depicting a controller-host system, within which one example embodiment may be deployed.

FIG. 2 is a communications flow diagram depicting example communications that may be passed within the controller-batch system, according to an embodiment.

FIG. 3 is a diagrammatic representation of a machine in the example form of a computer system within which a set of instructions, for causing the machine to perform any one or more of the methodologies discussed herein, may be executed.

### DETAILED DESCRIPTION

Example methods and systems to validate internal data in batch applications are described. In the following description, for purposes of explanation, numerous specific details are set forth in order to provide a thorough understanding of example embodiments. It will be evident, however, to one skilled in the art that the present invention may be practiced without these specific details.

In a distributed computing environment, batch applications are used to perform large tasks that can be performed offline (e.g., neither in real time nor in response to user inputs) and can be scheduled to occur during non-peak hours or over a long period of time (e.g., days). A batch application may run on one machine or multiple machines, or more than one batch application may run on one machine.

In a distributed computing environment, batch applications operate using a master-slave computing paradigm where a master computing system commands a slave computing system to run the batch application according to the schedule and using predefined parameters, pathways, and resources. Because batch applications are run on slave computing systems, they are “continuous” in that, once an application is initiated, there is no way to control it except for terminating the entire batch application. To modify the batch application, an operator first terminates, then reconfigures and restarts the batch application.

Typically, the results of the batch application are reported when the batch is terminated or when execution is completed. In some instances, a batch application may log pre-determined data during execution or transmit a status (e.g., 10% complete) during execution. It is desirable to have the ability to receive feedback and validated internal data while executing the batch application. The validated internal data may include, in a distributed computing environment, a number of email connections opened, number of database connections opened, and the memory usage of the batch application.

Further, based on feedback received from the batch application, it may be desirable to control or modify the batch application. For example, an operator may desire to speed up or slow down the execution of the batch application, change the number of threads used by the batch application, change the priority of the batch application, comply with Service Level Agreements (SLAs), or otherwise control capacity and demand for the resources in the computing environment.

To control or modify a batch application after it is initiated (and without terminating the batch application), batch agents are added to the machines running the batch application. The batch agents establish a communication protocol and an application programming interface (API) to manage the batch applications running on the machine. When initiated, the batch application registers to the batch agent on the machine and establishes the communication channel using the communication protocol. Using the communication channel, the batch application can report validated internal data in the application layer. The validated internal data may be communicated via a monitoring and management interface used as a part of administrator console. The internal data includes application run time state such as memory use, queue size, thread states and stacks, processing time, database connections etc. The management interface allows a user to make configuration changes such as number of threads, maximum queue size, and the like.

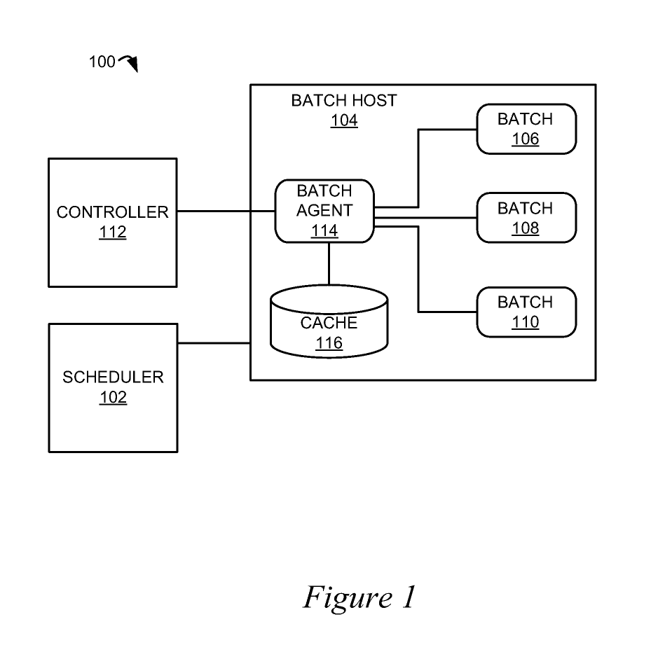

FIG. 1 is a network diagram depicting a master-host system, within which one example embodiment may be deployed. The controller-host system 100 comprises a scheduler 102, a batch host 104, and a controller 112.

The scheduler 102 is to schedule and initiate the batch applications. The scheduler 102 may provide a user interface for scheduling the batch applications. The batch applications may be scheduled on a periodic basis (e.g., daily, weekly, monthly) or in response to an event. The scheduler 102 sends a command to the batch host 104 to initiate a batch application. The scheduler 102 may manage more than one batch host 104. In some instances, the scheduler 102 may receive a status update from the batch host 104 or may receive a log file indicating some status of a particular batch application. The scheduler 102 may cause a batch application to be terminated during execution in response to an event or a user command. Upon completion of a batch application, the scheduler 102 may receive a report from the batch application.

The batch host 104 runs one or more batch applications (or portions thereof) in response to a command from the scheduler 102. The batch applications depicted in FIG. 1 include batch 106, batch 108, and batch 110. The batches of FIG. 1 may be implemented as Java Bean or using other programming languages.

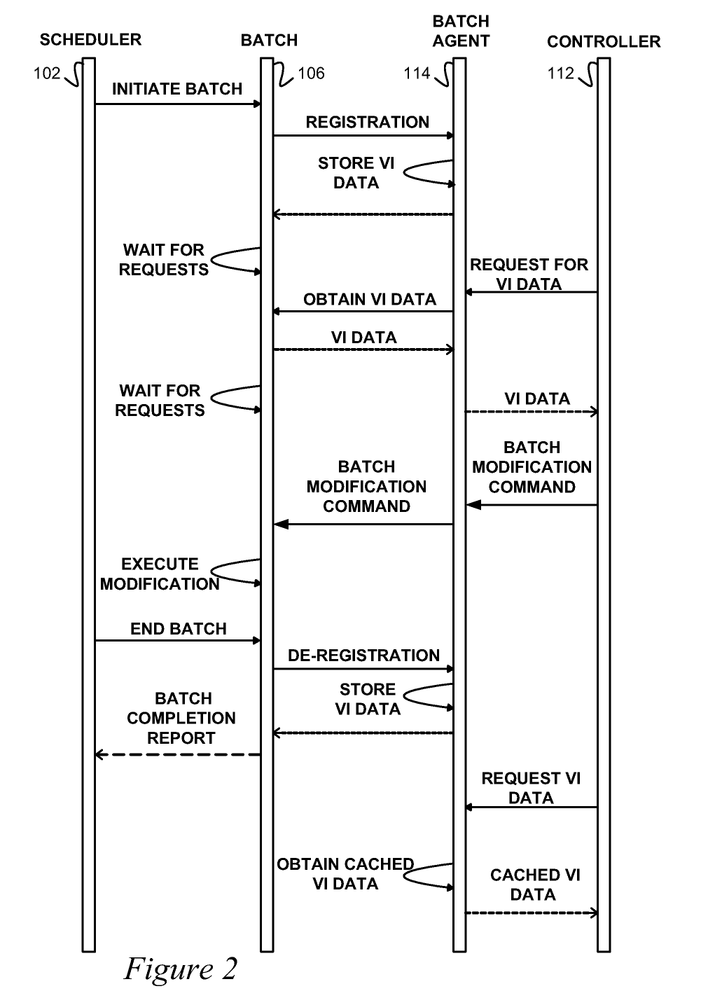

Each batch 106, 108, and 110 has a respective interface (not depicted) to communicate with a batch agent 114. As explained in greater detail in connection with FIG. 2, the interface is used to communicate validated internal data, requests, and commands between the batches 106, 108, and 110 and the batch agent 114. The exposed interface may be implemented using a communications protocol such as transmission control protocol/Internet protocol (TCP/IP), hypertext transfer protocol (HTTP), a secure socket layer (SSL), or the like. Even without a respective interface, the batches 106, 108, and 110 are still able to communicate with the scheduler 102.

Upon initiation of the batch application by the scheduler 102, the initiated batch application registers with the batch agent 114 to “bootstrap” or activate the communication channel between the batch application and the batch agent 114. When the batch application is terminated (e.g., by the scheduler 102) or completed, the batch application de-registers from the batch agent 114.

The batch agent 114 interfaces with the controller 112 that, in turn, provides a user interface for monitoring and modifying the batch applications (e.g., batch 106, batch 108, and batch 110). The single batch agent 114 may communicate with each respective batch application executed by the batch host 104. Alternatively, the batch host 104 may include a batch agent 114 for each batch application (or for a portion of the batch applications) running on the batch host 104.

The batch agent 114 provides monitoring and management information for the batch host 104 itself. The monitoring information includes server load, top running processes, file system usage, directory structure and file contents, process runtime details and support other user query-able information. The management interface for batch agent 114 may be used to make system and process changes (e.g., priorities and configuration) for running processes on the batch host 104.

The batch agent 114 is further used to store validated internal data in a cache 116 for later retrieval. The validated internal data in the cache 116 may be received from the batch applications (e.g., batch 106, batch 108, and batch 110) during or subsequent to execution. The validated internal data may comprise logged data, data stored in response to a pre-defined trigger, data stored in response to a request from the controller 112 or the batch agent 114, or data sent to the scheduler 102. The data in the cache 116 may be retrieved by the batch agent 114. While the cache 116 is shown as being internal to the batch host 104, the cache 116 may be separate from the batch host 104. For instance, the cache 116 may be within another batch host, within the controller 112, or may be a separate database.

The controller 112 is to communicate with the batch agent 114 via an HTTP connection to monitor and control the batch applications (e.g., batch 106, batch 108, and batch 110) executing in the batch host 104. As shown, the controller 112 is separate from the scheduler 102 as may be desirable in instances where a legacy scheduler (that is unable to monitor or control the running batch applications) is in communication with the batch host 104.

The controller 112 further provides a user interface to an operator. Using the interface, the operator may query the batch agent for real-time information about the batch applications (e.g., validated internal data) and control the execution of the batch applications. The validated internal data may include data about which batch applications are running, memory usage, execution threads open, data sent or received, email connections opened, database connections opened, a number of emails generated, and the like.

To control or modify the execution of the batch application, the controller 112 may send one or more commands to the batch application via the batch agent 114. Examples of modifications include controlling the speed at which the batch application is being executed by, for example, adding or closing execution threads, adding or closing database or email connections, allocating memory space to or de-allocating memory space from the batch application, or the like.

In some instances, the batch applications (executing offline) may share resources with online applications. To maintain SLAs or to comply with performance criteria, the controller 112 may modify the batch applications (via the batch agent 114) to allocate more or fewer resources to the batch applications. In some instances, the controller 112 receives a command to modify the batch applications from an operator via a user interface. Alternatively or additionally, the controller 112 may modify the batch applications in response to an event based on a pre-defined trigger or threshold.

It is noted that the functionality of scheduler 102 and the controller 112 may be combined into a single component. In instances where the scheduler 102 and the controller 112 are separate, the controller 112 does not affect the operation of the scheduler 102 or otherwise communicate with the scheduler 102. In some instances, the scheduler 102 may not be aware of the controller 112.

FIG. 2 is a communications flow diagram depicting example communications that may be passed within the controller-batch system, according to an embodiment.

To initiate a batch application, the scheduler 102 sends an “initiate batch” command to a batch host 104 (not depicted in FIG. 2), which, in turn, initiates a batch 106. The batch 106 sends a registration message to a batch agent 114 within the batch host 104. The batch registration message includes validated internal (VI) data about the batch 106. The VI data in the registration may include initial pathways or resources used by the batch 106 as dictated by the scheduler 102. The batch agent 114 stores the VI data in, for example, the cache 116 (not depicted in FIG. 2) and opens a communication channel between the batch 106 and the batch agent 114 (depicted by the dotted line).

Once the communication channel is opened, the batch 106 waits to receive queries for VI data and commands to modify the execution of the batch 106. When the controller 112 sends a request for VI data to the batch agent 114, the batch agent 114 obtains at least a portion of the requested VI data from the batch 106. In some instances, at least a portion of the requested VI data may be retrieved from the cache 116 (not depicted). The VI data is then transmitted from the batch 106 to the batch agent 114 (where it may be added to VI data retrieved from the cache 116) and on to the controller 112. The operations used to request and obtain VI data may be repeated throughout the execution of the batch 106.

In response to the VI data received at the controller 112, a command received from an operator, or an event associated with a pre-defined trigger, the controller 112 may transmit a batch modification command to the batch agent 114. The batch agent 114 then sends the command to the batch 106 where the batch executes the modification. The operations used to transmit and execute a batch modification command may be repeated throughout the execution of the batch 106.

When the batch 106 completes or if the scheduler 102 terminates the batch application before it is completed, the scheduler 102 sends an “end batch” command to the batch 106. Upon receiving the “end batch” command, the batch de-registers from the batch agent 114. The de-registration message may include VI data that is stored in the cache 116 by the batch agent 114. The batch agent 114 may then close the open communication channel (depicted by the dotted line) with the batch agent 106. The batch 106 then sends a batch completion report to the scheduler 102.

After the batch 106 is complete, the controller 112 may request VI data about the batch 106. The batch agent 114 obtains the VI data from the cache 116 and transmits it back to the controller 112.

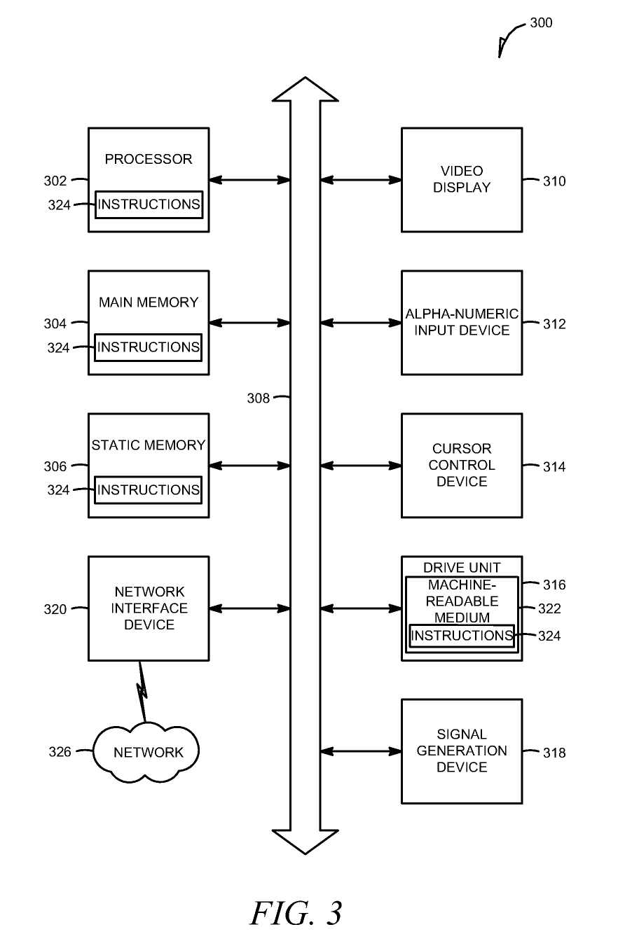

FIG. 3 shows a diagrammatic representation of machine in the example form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU), or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software RR24) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and a system to validate internal data in batch applications have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a batch host to host an instance of a running batch application, the running batch application comprising an interface to a batch agent; and
a controller in communication with the batch agent, the controller to request validated internal data about the running batch application via the batch agent and to receive the validated internal data about the running batch application from the batch agent.

2. The system of claim 1, further comprising a scheduler to initiate the running batch application.

3. The system of claim 2, wherein the scheduler is further to terminate the running batch application.

4. The system of claim 2, wherein the scheduler is to receive a status update or a log file from the running batch application.

5. The system of claim 1, further comprising a cache in communication with the controller, the cache to store the validated internal data.

6. The system of claim 1, wherein the validated internal data is selected from a group consisting of an identifier of the running batch application, memory usage, execution threads opened, data sent or received, email connections opened, database connections opened, and a number of emails generated.

7. The system of claim 1, wherein the interface is selected from a group consisting of transmission control protocol/Internet protocol (TCP/IP), hypertext transfer protocol (HTTP), and a secure socket layer (SSL).

8. The system of claim 1, wherein the controller is further to provide a command to the batch agent, the command being to modify the running batch application.

9. The system of claim 8, wherein the command is to modify a speed of execution of the running batch application.

10. The system of claim 8, wherein the command is selected from a group consisting of adding execution threads, closing execution threads, adding database connections, closing database connection, adding email connection, closing email connections, allocating memory space to the running batch application, and de-allocating memory space from the batch application.

11. The system of claim 8, wherein the command is provided in response to an event detected based on a pre-defined triggering condition.

12. The system of claim 11, wherein the pre-defined triggering condition is based on a service level agreement (SLA).

13. The system of claim 8, wherein the command is provided based on the received validated internal data.

14. The system of claim 1, wherein the controller is further to receive a request for the validated internal data via a user interface.

15. The system of claim 1, wherein the controller is further to receive a command to modify the running batch application via a user interface.

16. The system of claim 1, wherein the running batch application is to register with the batch agent.

17. A method comprising:
using one or more processors, providing a communication channel between a running batch application and a batch agent in a batch host upon initiation of the batch application in the batch host;
receiving a request for validated internal data from a controller;
obtaining the validated internal data from the running batch application via the communication channel; and
providing the validated internal data to the controller.

18. The method of claim 17, further comprising:
modifying the running batch application based on a command to modify the running batch application received from the controller.

19. A non-transitory computer-readable storage medium having instruction embodied thereon, the instruction executable by a processor for performing a method comprising:
providing a communication channel between a running batch application and a batch agent in a batch host upon initiation of the batch application in the batch host;
receiving a request for validated internal data from a controller;
obtaining the validated internal data from the running batch application via the communication channel; and
providing the validated internal data to the controller.

20. A system comprising:
means for hosting an instance of a running batch application, the running batch application comprising an interface to a batch agent; and
means for requesting validated internal data about the running batch application via the batch agent and for receiving the validated internal data about the running batch application from the batch agent.
